(19) United States
(12) Patent Application Publication
(10) Pub. No.: US 2002/0133547 A1
(43) Pub. Date: Sep. 19, 2002

(54) Method and system for real time net communication under the basis of documents

(75) Inventor: Luen-Wuu Lin, Taipei (TW)

Correspondence Address: LOWE HAUPTMAN GOPSTEIN GILMAN & BERNER, LLP, Suite 310, 1700 Diagonal Road, Alexandria, VA, 22314, US

(73) Assignee: CORETEX LIMITED

(21) Appl. No.: 09/805,879

(22) Filed: Mar. 15, 2001

(51) Int. Cl. G06F 15/16

(52) U.S. Cl. 709/204; 709/231; 709/228

(57) ABSTRACT

A method and system for real time communication for a plurality of clients over a network includes connecting a plurality of clients, senders and receivers, with at least one server over the network. The sender sends information, including a chat message and a page message with multi formats, for communication to the server. The server generates a URL address correlating to the page message and transmits the chat message and the URL address to the receiver. The receiver displays the chat message on a dialog window and the page message on the reference window for communication.

### FIELD OF THE INVENTION

This invention relates to a method and system for net communication, and specifically relates to a method and system for real time net communication under the basis of reference documents.

### BACKGROUND OF THE INVENTION

The business models of e-commerce shown at present are almost that on-line users browse the web site and search for the information they want and at last deal some transactions independently without proper negotiation with sellers over the network. This is mostly because the network, especially the Internet, lacks of a good communication platform supporting net communication. The major method for communication of the above-mentioned is that users use web application programs supplied by servers over the network and follow the logic architecture of programs defined by programmers of the web site. Therefore, there are plural limitations among users as browsing the web site or interacting with each other on the web site. Moreover, the e-commerce negotiating on the web site often makes people uncomfortable because of the transaction platform lacks of humanity and, more specifically, one instant, real time communicating structure to meet the requirement of both sides to reduce the tangible distance between service suppliers and service receivers over the network.

Among the present environment of the Internet, there are some kinds of models for net conference as below. First, the communication model under the basis of a character string or a textual file, e.g., the Internet Relay Chat (ICQ) system for direct communication among on-line users, or the talk (TALK) system on one sever for one user to another. Secondly, the communication model under the basis of audio and/or video data files, e.g., the Iphone, or the video conferencing system, etc. The former is communicated by text, thereby the quantity of exchange data is much less. The requirement for bandwidth is also lower. On the aspect of speed for communication, it though could meet the need of users, yet, regarding of transmitting image and/or voice data files for more proper and clear communication, the former system under the basis of text is far from capable of serving well. On the other hand, the latter, the one transmitting data of the format of audio and/or video datagram files, has a high dependence on the bandwidth. Although the information such as user's tone or body language would be much clearer for users, the hardware or the infrastructure of the network so far has a burden for such information transmission with large data quantity. Therefore, in order to resolve the difficulty mentioned above, users are enforced to accept the intermittent transmission of audio and/or video data files or even to construct the expensive private network for better communication quality.

Accordingly, owing to the limitation of data transmission over the network, it's difficult for users on line to express more complicated information contents with each other. It is crucial to improve the method and the communication system described above to provide a cheaper, more convenient, and faster communication method and system over the network to transmit precisely the meanings and contents of information.

### SUMMARY OF THE INVENTION

It is therefore an object of the present invention to provide a method and system for communication over a network.

It is another object of the present invention to provide a method and system for mutual communication under the basis of documents with multi formats over a network.

It is a further object of the present invention to provide a real-time and interactive communication method and system under the basis of documents with multi formats over a network.

The present invention discloses a method and system for mutual communication under the basis of documents with multi formats over a network. The system construct a server on the network and after any users login the server system, they could communicate with the others on this network system under the basis of documents with multi formats to negotiate the details of business or any other things or even to promote deals of e-commerce.

More specifically, after one communication connection over the network has been setup, at least two windows for communication have been created at display devices of each client on that communication connection. The first window is the basic dialog one for chat messages to exchange ideas and opinions of each client. The formats of files transmitted could be a character string or text files sent and received, or be video and/or audio files or the like to communicate directly. Meanwhile, The second one, or the third window is for instantly displaying graphic files, HTML files, XML files or the like for clients to communicate with each other more precisely and easily.

Users on client environment could instantly transmit documents with any formats, e.g., a character string, HTML, XML, JPEG, GIF, WORD or any kind of files, which a browser could browse. Each client has at least two windows shown on his displaying device, such as a screen or a monitor, to exchange information of both sides. For example, if a character string is sent by the first dialog window of a sender, then that a character string will be received and shown by the first dialog window of a receiver. Similarly, if a graphic file is sent by the second dialog window of a sender, then that graphic file will be received and shown by the second dialog window of a receiver, etc.

The method taught by the invention for transmitting information, data, or control commends by senders or receivers would include two connection models of connecting clients through servers, i.e., communicating indirectly and connecting clients not through servers, i.e., communicating directly.

### BRIEF DESCRIPTION OF THE DRAWINGS

The features and advantages of the present invention will become apparent from the following drawings of the present invention in which:

FIG. 1 is a diagram illustrating schematically whole architecture of real-time mutual communication system of the present invention;

FIG. 2 is a diagram illustrating schematically the processes of mutual communication system under the basis of documents with multi formats of the present invention;

FIG. 3 is a diagram illustrating schematically architecture of indirect mutual communication system of clients and servers of the present invention;

FIG. 4 is a diagram illustrating schematically a flow chart of sending information by the indirect mutual communication system of a client of the present invention;

FIG. 5 is a diagram illustrating schematically a flow chart of receiving information by the indirect mutual communication system of a client of the present invention;

FIG. 6 is a diagram illustrating schematically a flow chart of indirect mutual communication system of a server of the present invention;

FIG. 7 is a diagram illustrating schematically architecture of direct mutual communication system of clients and servers of the present invention;

FIG. 8 is a diagram illustrating schematically a flow chart of sending information by the direct mutual communication system of a client of the present invention; and

FIG. 9 is a diagram illustrating schematically a flow chart of receiving information by the direct mutual communication system of a client of the present invention.

### DETAILED DESCRIPTION OF THE PREFERRED EMBODIMENT

The present invention discloses a method and system for communication over a network. It would be applied to many applications on the Internet, such as applied to the communication between sellers and buyers of e-commerce, or the communication between the teacher and students of long-distance teaching. The present invention also provides a communication mechanics between products and/or service providers and demanders. In the following description, for purposes of explanation, numerous specific details are set forth in order to provide a thorough understanding of the present invention. It will be evident, however, to one skilled in the art that the present invention may be practiced without these specific details.

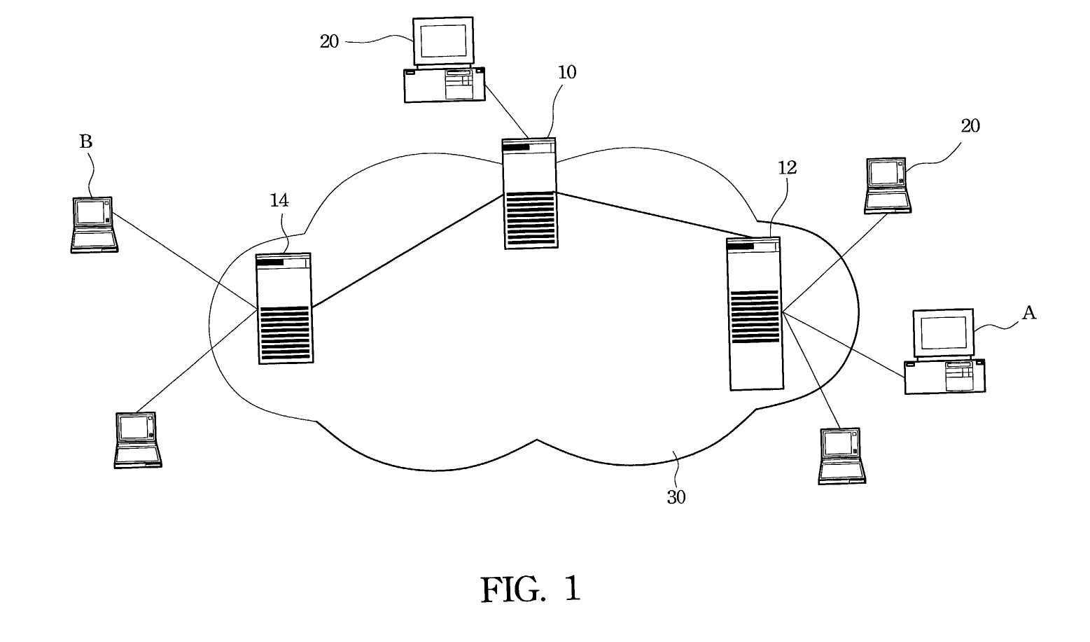

The present invention mainly utilizes a Web technology to construct a PageMessenger server environment for mutual communication over a network, the Internet or the like. FIG. 1 illustrates whole architecture of the present invention. Over the network, a plurality of PageMessenger servers 10 and PageMessenger clients 20 of both senders and receivers are coupled via a network connection device, wherein clients 20 would be terminal devices, such as personal computers or personal digital assistants. Such connection between servers 10 and clients 20 coupled to the network would be wired or wireless. After a PageMessenger client 20 links to the network and logins to a PageMessenger server 10, the PageMessenger client 20 would be located in a mutual communication environment 30 for facilitating to be found or searched by other clients 20 also on this environment 30 and thus setup a communication connection.

After the PageMessenger server 10 accepts a PageMessenger client 20 to be connected with, the server 10 would then would require a directory server (not shown) to denote that user is an ‘Active’ user. For simplicity, in the following description, an ‘A’ is used to stand for an ‘Active’ user. Meanwhile, record which PageMessenger server 12 did the user A login. Therefore, the latter on-line ‘Active’ user, called ‘B’ for short, would find ‘A’ according to the above mention and even demand to setup a communication connection.

As the PageMessenger server 14 receive the requirement, delivered from the user B, for constructing a connection to user A, the server 14 will ask the directory server whether user A is a on-line active one. If yes, then the server 14 will proceed to connect to user A.

There are two ways for user A and user B to connect. The first one is that user A and user B respectively connect and login to the PageMessenger server 12 and 14. Any exchanging information of user A and user B are transmitted and delivered by the PageMessenger server 12 and 14. More specifically, if client A tends to send information to client B, no matter the information is a chat message or a page message including of documents with multi formats, the information is always transmitted to the PageMessenger server 12, which user A logins, then through the PageMessenger server 14, which user B logins, and at last received by user B. The PageMessenger server 12, which user A logins, and the PageMessenger server 14, which user B logins, could be the same server 10, for example. The second way for user A and user B to connect is that user A ask the PageMessenger server 12, which user A logins, what location the user B is, and then the information is directly transmitted to user B without through any PageMessenger server.

Different information could be delivered on the same communication connection over the network. The information includes two types of data formats. One is the chat message, such as a character string, text, audio stream, video stream or other data format for dialog. The other type is the page message with a hypertext format, which the browser can browse, such as HTML, XML, WORD, EXCEL, POWERPOINT, etc., as dialog reference data for each client on line.

Once the communication connection for both user A and user B has been setup, at least one window will be correspondingly created for client A and client B respectively for real-time communication. If client A and client B need just to talk to each other without any page message, then both sides would respectively create only one dialog window. On the other aspect, if client A and client B need other page message to facilitate the proceeding of communication or negotiation, then both sides would respectively create another window or more for simultaneously providing and displaying necessary documents or files, which are transmitted to each other via the communication connection over the network. Typically, the information transmitted from the Nth window of a sender would be also relatively displayed on the Nth window of a receiver. For example, one page message transmitted from the forth window of client A would be correspondingly displayed on the forth window of client B.

The method of communication over the network and through the PageMessenger server 10 as described above could be also applied to the communication of one client to the others. For example, client A would transmit chat messages or page messages to client B, client C, client D or any others via the PageMessenger server 12. Similarly, client B would also transmit chat messages or page messages, via the PageMessenger server 14, to client A, client C, client D or any others under this group of real-time communication server environment.

Under the real-time communication server environment, the reference information transmitted between clients would be not only the local information of client sides, i.e., data files like saved in the storage media of clients, but also including the data shown on websites on the Internet. If the information delivered is the local data or files, then the client, who initiates to deliver, would upload the local data to the PageMessenger server, which the client logins. Moreover, if the local data is, for example, the HTML data file, then the relative sub-layer data, such as graphics, audio data, video data, frame or the like should also be uploaded to the PageMessenger server simultaneously. The PageMessenger server would thus generate and feed back a temporary universal resource locator (URL) address correlating to the data, receives from the client, to the client and then the client transmits the temporary URL address to the others to download those data for the purpose of simultaneously real time communication on line. On the other hand, if a client wishes to send the webpag data, which have been existed on the Internet, the client would just directly transmit the URL of that web page to other receivers to download those data thereof.

Besides, clients could communicate directly over the network. A client initiates to transmit the local data directly to the receiver. A message handling module of the receiver could save the data in the storage media and then delivers the correlative storage address to the displaying window to show the data.

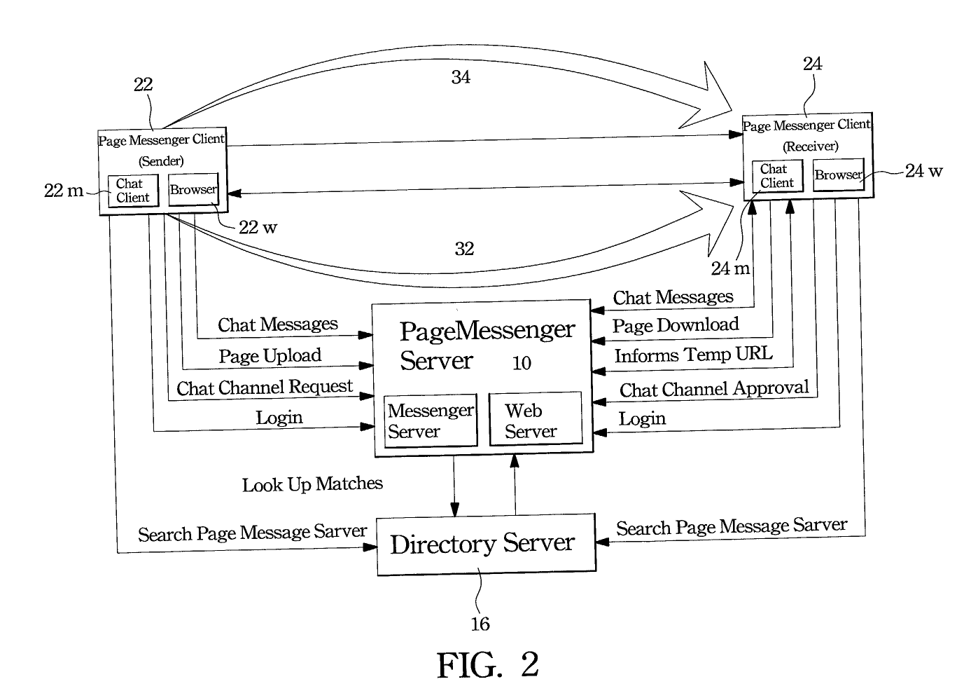

Referring to FIG. 2, a diagram illustrates the processes of mutual communication system under the basis of documents with multi formats of the present invention. The processes include two types of communication mechanics. One is the indirect mutual communication mechanics 32 and the other is the direct mutual communication mechanics 34. There are three parts of this whole communication mechanics. The first part includes the PageMessenger sender 22 and the PageMessenger receiver 24. The second part is the PageMessenger server 10 and the third part is the directory server 16.

If the PageMessenger sender 22 desires to communicate the PageMessenger receiver 24 by means of the indirect mutual communication connection 32, an acted PageMessenger server 10 under a mutual communication environment must be found out first. Meanwhile, there are two ways for searching the acted PageMessenger server 10. The first one is to search the previous records, saved in the PageMessenger client and the other method is to search a variable PageMessenger server address by means of the directory server 16. Then, both login the PageMessenger server and transmit the chat message or the page message indirectly through the server.

Moreover, the PageMessenger sender 22 could directly transmit the chat message or the page message, by means of the direct mutual communication connection 34, to the PageMessenger receiver 24. The PageMessenger sender 22 could change its role with the PageMessenger receiver 24, i.e., the PageMessenger receiver 24 would initiate to transmit the chat message or the page message to the PageMessenger sender 22. Accordingly, the PageMessenger receiver 24 would turn to be a sender and the PageMessenger sender 22 would turn to be a receiver. For simplicity, the present invention just displays one sending and receiving direction, but not to be construed in a limiting sense.

The function of the PageMessenger server 10 mainly includes to receive the chat message and the page message delivered from the PageMessenger sender 22 and to transmit the information to the PageMessenger receiver 24. Suppose that the PageMessenger sender 22 and the PageMessenger receiver 24 login the same PageMessenger server 10. Then the PageMessenger server 10 would directly pass the information to the PageMessenger receiver 24. Meanwhile, during the process of communication, the PageMessenger server 10 would inquire the directory server 16 about some parts of the information, such as the verification for user's ID or the address of a PageMessenger server. In short, the main function of a PageMessenger server comprises to accept for login, to transmit the chat message and the page message between senders and receivers in an indirect means and to provide a name list for dialog including service providers and service demanders.

The directory server 16 provides a fast data searching service for the PageMessenger server 10 and PageMessenger clients 22 and 24. The service provided includes providing the basic information of users who login the PageMessenger server, identifying the users, providing on-line dialog group lists, service provider lists, service demander lists and the PageMessenger server lists which the servers have been already acted and ready for providing service, etc. All records are saved in the directory server 16 to provide searching service to any entity on this mutual communication environment.

The whole mechanic of mutual communication referring to FIG. 2 is that the PageMessenger sender 22 and the PageMessenger receiver 24 respectively finds an address of the PageMessenger server 10 via a directory server 16 and logins therein or the PageMessenger sender 22 and the PageMessenger receiver 24 respectively logins the PageMessenger server 10 according to the address thereof recorded in the PageMessenger sender 22 and the PageMessenger receiver 24. If there is no one on line for communication after the PageMessenger sender 22 logins, the PageMessenger sender 22 can require the directory server 16 to provide a list of new users for communication and accordingly request to setup a chat channel with the PageMessenger receiver 24. Supposed the PageMessenger 24 agrees, then a message channel would be connected successfully with the PageMessenger sender 22 and the chat message and the page message could be transmitted through this message channel. More specifically, the chat message is transmitted to the PageMessenger receiver 24 via the PageMessenger server 10 without any further process to deal with. Meanwhile, the page message would upload to the PageMessenger server 10 first and receive a temporary URL, correlative to the page message. Then, the PageMessenger sender 22 transmits the temporary URL address to the PageMessenger receiver 24 and the web browser 24w of the PageMessenger receiver 24 downloads and displays the page message correlative to the web URL address for the purpose of mutual communication between each other. If the PageMessenger sender 22 sends web page data, which have already existed on the Internet, the PageMessenger sender 22 can just send the URL address directly to the PageMessenger receiver 24 to download the data for the proceeding communication.

On the other hand, if the PageMessenger sender 22 gets the address of the PageMessenger receiver 24, e.g., the IP address, from the PageMessenger server 10, both clients 22 and 24 would communicate by means of the direct connection 34 and the chat message and the page message accordingly could be transmitted to the PageMessenger receiver 24. Then, the PageMessenger receiver 24 directly displays the chat message on the dialog windows and saves the page message in a temporary directory. After the file address correlative to the page message in the local area transmitted to the reference window, the PageMessenger receiver 24 would display the page message on the reference window.

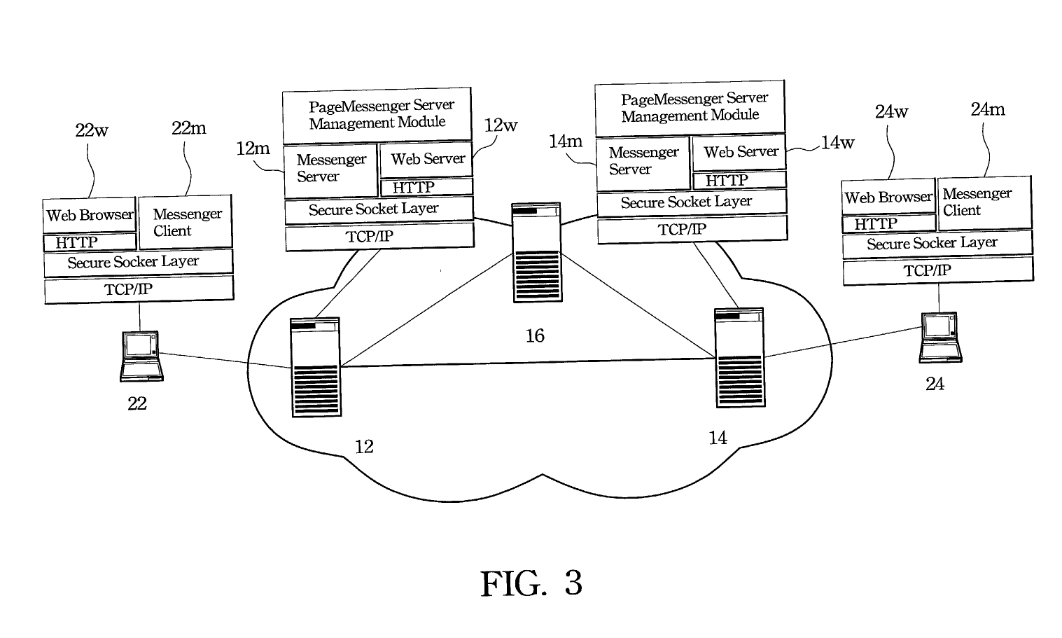

Referring to FIG. 3 illustrates architecture of indirect mutual communication system of clients and servers of the present invention. The chat message and the page message of clients are transmitted via the PageMessenger server. Specially, the number of the PageMessenger server between clients depends on that whether clients login the same server or not, maybe one or more. If both clients 22 and 24 respectively login the PageMessenger server 12 and 14 rather than the same one, the PageMessenger server 12 would receive the chat message transmitted from the PageMessenger sender 22 and then get the address of the PageMessenger server 14, which the client 24 logins, from the directory server 16 and deliver the chat message to the server 14. The PageMessenger server 12 also transmits the page message sent by the PageMessenger sender 22 to The PageMessenger receiver 24. More specifically, the PageMessenger sender 22 gets a temporary URL address correlating to the page message from the PageMessenger server 12 and sends this temporary URL address as the way of sending the chat message mentioned above to the PageMessenger client 24. The PageMessenger receiver 24 therefore downloads the page message according to this temporary URL address. Note that if more than one PageMessenger server existing between the clients 22 and 24, the page message would not be transmitted to the PageMessenger server 14, which the client 24 logins, but just the temporary URL address correlating to the page message of the PageMessenger server 12, which the client 22 logins, would be transmitted.

As shown in FIG.3, the PageMessenger server 12 could receive the chat message which is transmitted from the messenger client 22m of the PageMessenger sender 22 and then deliver the chat message to the messenger client 24m of the PageMessenger receiver 24. The web servers of the PageMessenger server 12 and 14 provide generally not only the service of downloading the web page, but also the service of transmitting the page message from senders to receivers. The PageMessenger server 12 and 14 also include the management modules means for managing the chat channel and the on-line group lists, etc.

The bottom layer of indirect mutual communication module protocol of the present invention includes HTTP, HTTPS, SSL, TCP/IP, etc. However, the protocol herein is not construed in a limiting sense. Any applicable communication protocol and network security protocol could be the bottom layer protocol for communication of the present invention.

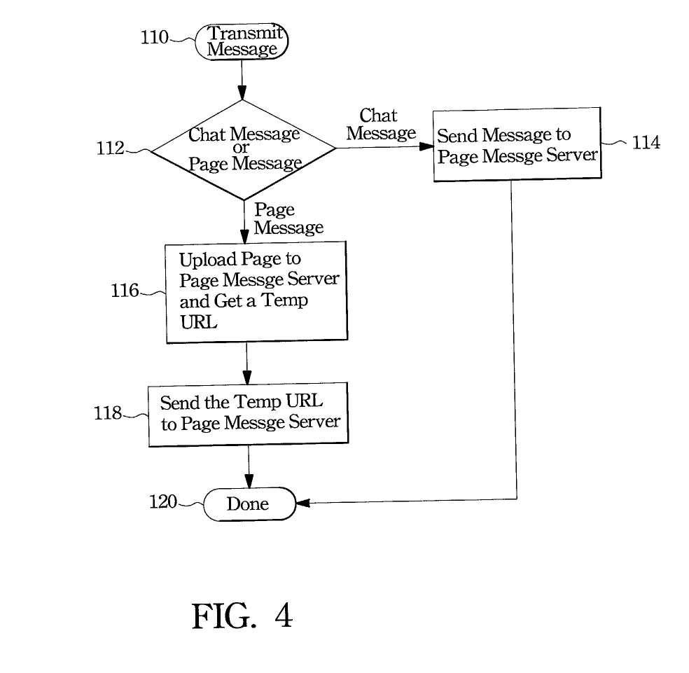

Referring to FIG. 4, illustrating a flow chart of sending information by means of the indirect mutual communication system of a client, and FIG. 3, the step 110 shows that the sender 22 sends information. The information further includes chat messages and page messages, as shown in the step 112. If the sender 22 sends chat messages, the sender 22 would transmit the chat messages according to the communication protocol to the messenger server 12m of the PageMessenger server 12, as shown in the step 114 of FIG. 4. The communication protocol of transmitting chat messages as mentioned above could be the popular Internet Relay Chat (IRC) protocol at present or the other applicable communication protocol for the network. If the PageMessenger sender 22 wishes to send a page message for dialog, the sender 22 would first upload the files correlative to the page message to the web server 12w of the PageMessenger server 12 and get a temporary URL address correlating to the page message, as shown in the step 116 of FIG. 4. In the step 118, after the sender 22 retrieves a temporary URL address from the web server 12w, the URL address is transmitted by the same way of transmitting chat messages to the messenger server 12m of the PageMessenger server 12. In the step 120 illustrates the sender 22 finishes the process of sending information. Moreover, if the page message further include more than one file, those files would be transmitted to the PageMessenger server 12 for one time or many times. Besides, because those files have formats of hypertext, the corresponding correlation between those files could be maintained during files transmitting so that the display sequence of those files, between senders and receivers, could be the same.

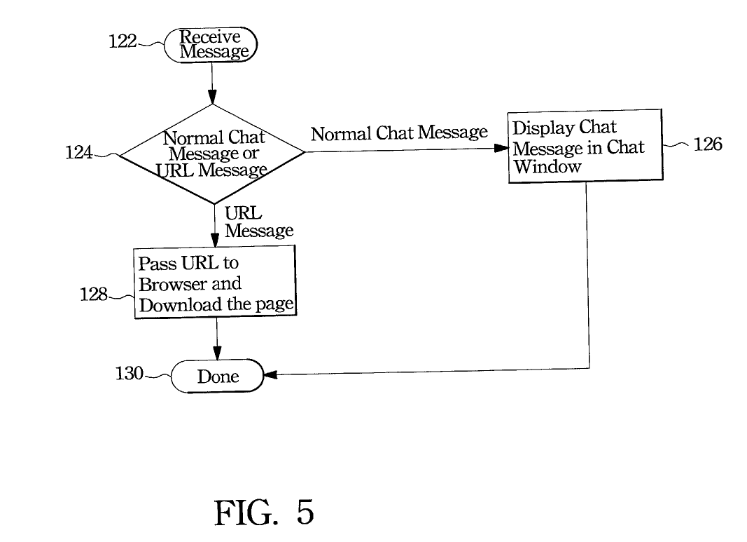

FIG. 5 illustrates a flow chart of receiving information of the indirect mutual communication system of a client of the present invention. Referring to FIG. 3 and FIG. 5, the step 122 shows that the receiver 24 receives information, including chat messages and/or a URL address, transmitted from the PageMessenger server 14. The step 124 shows that the receiver 24 analyzes the information to find out what the information are, chat messages or a URL address correlating to the page message? The step 126 illustrates that the information, transmitted from the PageMessenger server 14, are chat messages, then the messenger client 24m of the PageMessenger receiver 24 directly displays the chat messages on dialog window. The step 128 shows that the information, transmitted from the PageMessenger server 14, is a URL address correlating to the page message, then the web browser 24w of the PageMessenger receiver 24 downloads the web page of the URL address to display the page message existing in the web page for the basis of mutual communication of both clients 22 and 24. The step 130 illustrates that the receiver finishes the receipt of information.

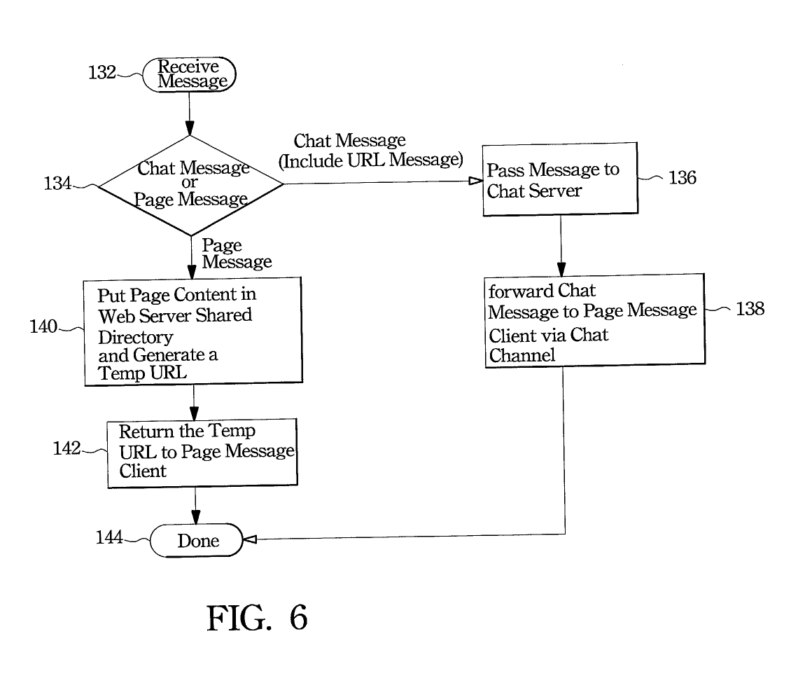

FIG. 6 is a diagram illustrating schematically a flow chart of indirect mutual communication system of a server of the present invention. Referring to FIG. 3 and FIG. 6, the step 132 shows that the PageMessenger servers 12 and 14 receive information, including a chat message and page message for dialog. In the step 134, the PageMessenger server 12 analyzes to find out what the information, transmitted from the sender 22, are a chat message or a URL address correlating to the page message? If the information is a chat message, then the chat message are transmitted to the messenger server 12m, as illustrated in the step 136. Then, transmit the chat message to the PageMessenger receiver 24 via the chat channel, through the messenger server 14m, as illustrated in the step 138. If the information is a page message, as shown in the step 140, then the files correlative to the page message would be saved in the web server 12w of the PageMessenger server 12 and a temporary URL address correlating to the page message would be generated accordingly on the PageMessenger server 12. In the step 142, the PageMessenger server feeds back the temporary URL address to the sender 22. As the sender 22 receives the URL address, the URL address would be transmitted, as the same transmission process as shown in the step 136, to the receiver 24 through the messenger servers 12m and 14m. The step 144 shows the completion of information transmission.

The embodiment of the present invention described above just show one direction of information transmission. It is to be understood that this description is by way of example only, and is not to be construed in a limiting sense. It is to be further understood that the information transmission of the present invention also could be executed in the adverse direction to achieve mutual communication.

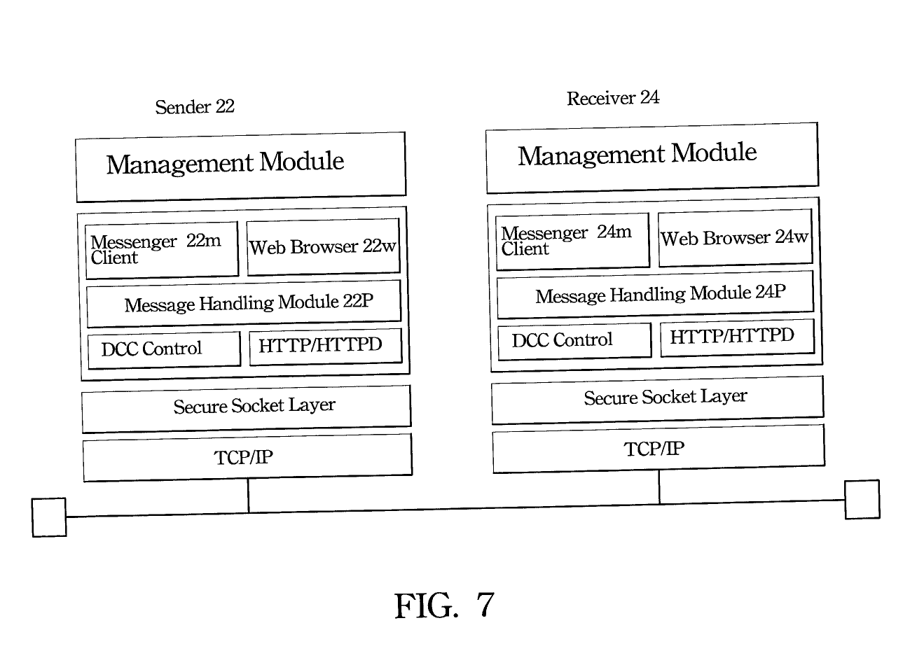

FIG. 7 illustrates the architecture of direct mutual communication system of clients and servers of the present invention. Herein the so called direct mutual communication system means that after the sender 22 and the receiver 24 get the other's address, usually the IP address, a direct channel for communication is setup, by no means of transmitting information via the PageMessenger server. That is the sender 22 transmits information directly according to the address of the receiver 24. Then, the receiver 24 receives the information transmitting from the sender 22 and proceeds different processes as below.

The “DCC” control in FIG. 7 stands for “Direct Client Channel” control. The function of “DCC” control is to send and to receive chat messages with each other, and also maintains the connection of clients and records the connection attributes during connection, e.g., on-line privacy, ID verification, the status of connection, etc. As the clients 22 and 24 receive chat messages transmitted from the other client, the chat messages would be transferred to the message handling modules 22p and 24p respectively and display the chat messages on the dialog windows of both sides.

The message handling modules 22p and 24p, shown in FIG. 7, also handle with files of page messages. In order to display the whole documents completely, the message handling module must maintain the corresponding correlation between those files, such as the corresponding correlation between HTML files, graphic files, audio files, video files, frame files or the like. Moreover, the files including the documents such as POWERPOINT, WORD, etc., are also controlled and managed by the message handling module to maintain the corresponding correlation between those files.

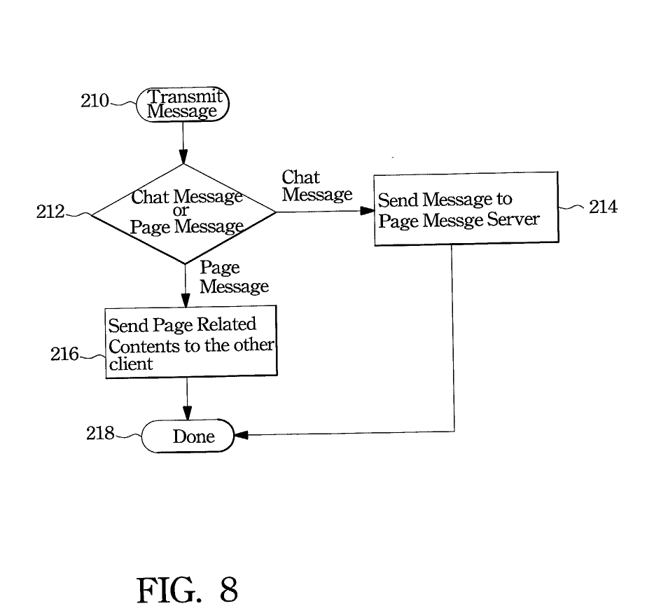

FIG. 8 illustrates a flow chart of sending information of the direct mutual communication system of a client. Referring to FIG. 7 and FIG. 8, the step 210 shows that the sender transmits information. More specifically, the sender do not transmit chat messages and page messages to the receiver via the PageMessenger server, but transmits the chat messages and the page messages directly to the receiver according to the IP address of the receiver, as described in the step 212. If the sender 22 transmits a chat message, as shown in the step 214, the chat message would be transmitted to the messenger client 24m of the receiver 24. The process of transmitting a chat message usually is simpler because the chat message includes a header and a character string or text so that it needs to be transmitted just one time. If the sender 22 transmits a page message, as shown in the step 216, the page message would be transmitted to the receiver 24. Then, the process of information transmission accordingly completes, as shown in the step 218. More specifically, the page message may further include more than one file and all relevant files should be transmitted together sequentially to the receiver. As a result, it needs many times to transmit such files. Note that the correlation between the page message files should be maintained as being transmitted from the sender to the receiver.

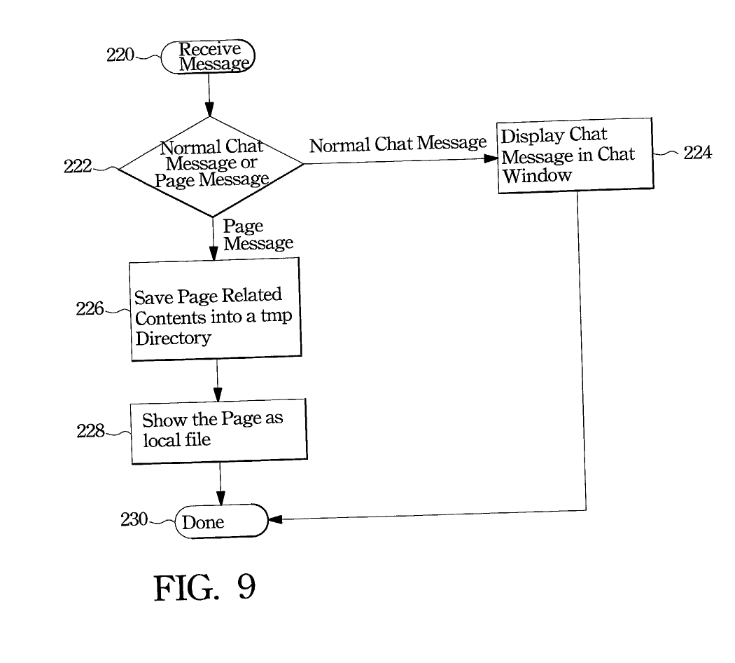

FIG. 9 illustrates a flow chart of receiving information of the direct mutual communication system of a client. Referring to FIG. 7 and FIG. 9, the step 220 shows that the receiver 24 receives information transmitted from the sender 22. The information includes chat messages and/or page messages, as shown in the step 222. If the receiver 24 receives a chat message, as shown in the step 224, the chat message would be directly displayed on the dialog window of the receiver 24 after the chat message has been analyzed by the message handling module 24p.

If the receiver 24 receives a page message, as shown in the step 226, the message handling module 24p would save the page message in a temporary address of a directory of the receiver 24, as shown in the step 228. Then the message handling module 24p would inform the browser of the receiver 24 to show the page message according the temporary address of the directory thereof. The step 230 thus shows the completion of information receipt and display.

As mentioned above, the present invention discloses a method and system for mutual communication under the basis of documents with multi formats over a network. The invention provides a server environment for any users over the network to login the server environment and then to communicate and to negotiate under such real-time communication system. Accordingly, the difficulty for traditionally unable to express the complicated information on the Internet has been thus solved. Besides, users could utilize the present invention to facilitate the Internet communication environment to enjoy cheaper, more convenient and plentiful net communication.

Although the invention has been described in detail herein with reference to its preferred embodiment, it is to be understood that this description is by way of example only, and is not to be construed in a limiting sense. It is to be further understood that numerous changes in the details of the embodiments of the invention, and additional embodiments of the invention, will be apparent to, and may be made by, persons of ordinary skill in the art having reference to this description. It is contemplated that such changes and additional embodiments are within the spirit and true scope of the invention as claimed below.

We claim:

1. A method for real time communication over a network, the method comprising:
connecting at least one sender and at least one receiver with at least one server over the network, each the sender and each the receiver having a first window and at least a second window for communication;
uploading communication information to the server by the sender, the communication information including a chat message, a page message and a URL address correlating to the page message;
transmitting the chat message and the URL address to the receiver; and
displaying the chat message on the first window and the page message at least on the second window of the receiver.

2. The method of claim 1, wherein the chat message is selected from the group consisting of character string, text, audio stream and video stream.

3. The method of claim 1, wherein the page message is selected from a hypertext group consisting of HTML files, XML files, WORD files, EXCEL files and POWERPOINT files.

4. The method of claim 1, wherein the step of uploading the communication information to the server by the sender is carried out by:
uploading the chat message and the page message to the server by the sender;
generating the URL address correlating to the page message by the server;
feeding back the URL address to the sender by the server; and
uploading the URL address to the server by the sender.

5. The method of claim 1, wherein the step of transmitting the chat message and the URL address to the receiver further includes following the protocol of Internet Relay Chat to transmit the chat message and the URL address.

6. The method of claim 1, wherein the step of displaying the page message at least on the second window of the receiver further includes to download the page message in a web page of the URL address on the server.

7. The method of claim 6, wherein the page message further include more than one file, the corresponding correlation between the files are maintained before being transmitted.

8. The method of claim 1, wherein the network is the Internet.

9. The method of claim 1, wherein the step of connecting at least one the sender and at least one the receiver with at least one the server over the network is carried out by:
finding each address of at least one the server on a directory server; and
connecting at least one the sender and at least one the receiver with respect to each the address of at least one the server over the network.

10. A method for real time communication over a network, the method comprising:
connecting at least one sender and at least one receiver over the network, each the sender and each the receiver having a first window and at least a second window for communication;
transmitting communication information to the receiver by the sender, the communication information including a chat message, a page message;
saving the page message in a temporary address of a directory of the receiver; and
displaying the chat message on the first window and the page message according to the temporary address of the directory at least on the second window of the receiver.

11. The method of claim 10, wherein the chat message is selected from the group consisting of character string, text, audio stream and video stream.

12. The method of claim 10, wherein the page message is selected from a hypertext group consisting of HTML files, XML files, WORD files, EXCEL files and POWERPOINT files.

13. The method of claim 10, wherein the network is the Internet.

14. The method of claim 10, wherein the step of connecting at least one the sender and at least one the receiver over the network is to utilize the IP addresses of the sender and the receiver to connect the sender and the receiver over the network.

15. A system for real time communication over a network, the system comprising:
a plurality of clients connecting to the network, each the client being utilized to send at least a page message, at least a chat message and at least a URL address correlating to each the page message, to receive at least one the chat message and at least one the URL address, to create a first window for displaying at least one the chat message and at least a second window for displaying at least one the page message; and
at least one server connecting to the network, each the server being utilized to receive and to transmit at least one the chat message and at least one the page message, to generate at least one the URL address correlating to each the page message.

16. The system of claim 15, wherein each the client further includes a messenger client to send and to receive the chat message and the URL address and to display the chat message on the first window.

17. The system of claim 15, wherein each the client further includes a browser to download the page message according to the URL address and to display the page message on the second window.

18. The system of claim 15, wherein the chat message is selected from the group consisting of character string, text, audio stream and video stream.

19. The system of claim 15, wherein the page message is selected from a hypertext group consisting of HTML files, XML files, WORD files, EXCEL files and POWERPOINT files.

20. The system of claim 15, wherein the system further includes a directory server to provide a name list to each the client for searching another one of the clients for communication, the name list comprising IP addresses of each the client and addresses of each the server, which each the client logins.

21. The system of claim 15, wherein each the server further includes a messenger server to receive and to transmit the chat message.

22. The system of claim 15, wherein each the server further includes a web server to receive the page message from the client to generate the URL address correlating to the page message and to feed back the URL address to the client.

23. The system of claim 15, wherein the network is the Internet.

24. A system for real time communication over a network, the system comprising:
a plurality of clients connecting to the network, each the client including a message handling module to send and to receive at least a page message and at least a chat message, to create a first window for displaying at least one the chat message and at least a second window for displaying at least one the page message.

25. The system of claim 24, wherein each the client further includes a messenger client to send and to receive the chat message and to display the chat message on the first window.

26. The system of claim 24, wherein the chat message is selected from the group consisting of character string, text, audio stream and video stream.

27. The system of claim 24, wherein the message handling module saves each the page message in a temporary address of a directory of the client.

28. The system of claim 24, wherein each the client further includes a browser to download the page message according to the temporary address and to display the page message on the second window.

29. The system of claim 24, wherein the page message is selected from a hypertext group consisting of HTML files, XML files, WORD files, EXCEL files and POWERPOINT files.

30. The system of claim 24, wherein the system further includes a server to provide IP addresses of each of the clients for one of the clients to search another one of the clients for communication.

31. The system of claim 24, wherein the network is the Internet.
